(19) United States
(12) Patent Application Publication
(10) Pub. No.: US 2016/0243893 A1
(43) Pub. Date: Aug. 25, 2016

(54) MACHINE-MADE REINFORCING FIBER RIM FOR A VEHICLE AND METHOD OF MANUFACTURING SAID RIM

(71) Applicant: CarboFibretec GmbH, Friedrichshafen (DE)

(72) Inventors: Erhard WISSLER, Bissingen/Teck (DE); Thomas LESCHIK, Meckenbeuren (DE)

(21) Appl. No.: 15/011,168

(22) Filed: Jan. 29, 2016

(30) Foreign Application Priority Data
Feb. 20, 2015 (DE) 10 2015 102 465.9
Feb. 20, 2015 (DE) 10 2015 102 466.7

(51) Int. Cl. B60B 21/12; B29C 65/00

(52) U.S. Cl. CPC B60B 21/12; B29C 65/002; B29L 2031/32

(57) ABSTRACT

A rim for a vehicle comprising a tire contact to which a clincher or a tubed tire may be fastened is disclosed. The tire contact includes a core wrapped by reinforcing thread so that the core is covered by a supporting layer formed by the reinforcing thread. The tire contact is covered at least on the radial inside by the cover layer formed of reinforcing thread so that a reinforcing ring is provided between the cover layer and the tire contact. Methods of manufacturing fiber composite rims are also disclosed. A core is wrapped with a reinforcing thread to deposit a supporting layer on the core and to form a tire contact. The tire contact is arranged adjacent an aerodynamics enhancing component and a reinforcing ring. The tire contact, the aerodynamics enhancing component and the reinforcing ring are wrapped with one or more reinforcing thread(s) to form a cover layer.

### CROSS-REFERENCE TO RELATED APPLICATIONS

This Application claims priority of DE Application Nos.: 10 2015 102 465.9 and 10 2015 102 466.7, both filed on Feb. 20, 2015. Each of these priority applications is incorporated herein by reference in their entirety.

The invention relates to a rim for a vehicle such as a vehicle driven by an internal combustion engine, for example a car, a truck or a utility vehicle, or such as a muscle-powered and/or electrically driven vehicle such as a bicycle, for example a racing bike, a mountain bike or a triathlon bike, comprising a tire contact means which is prepared for fastening a clincher/clincher-tire or a hose/tubed/tubular tire, wherein the tire contact means includes a core which is wrapped (in the following description “(to) wrap” or “wrapping” can also be referred to as “(to) wind” respectively “winding”) by at least one reinforcing thread so that the core is covered approximately predominantly or completely by at least one supporting layer formed by the reinforcing thread. In the state of the art already a method of manufacturing a rim is known from DE 10 2007 042 198 A1. There especially a method of manufacturing a rim ring for a rim, especially for a clincher-rim, is suggested. The following steps are described therein: Providing an outer rim profile of hardened composite fiber material, providing a plastic molding element, providing at least one cover layer of composite fiber material, inserting the plastic molding element radially inside the outer rim profile and positioning the cover layer relative to the plastic molding element and to the outer rim profile so that at least part of the cover layer extends from the plastic molding element to the outside of the outer rim profile. This earlier document moreover relates to a method of fastening spokes made of composite fiber material to a rim ring. Finally the earlier document also relates to a rim ring, a clincher-rim and a bicycle including clincher-rims.

An apparatus and a method of manufacturing reinforcing fiber products are also known from WO 2011/096805 A1. This document especially discloses toroidal reinforcing fiber composite products.

Rims have been used on vehicles since long for supporting a tire. Such rims are used in vehicles driven by an internal combustion engine such as cars, trucks or other utility vehicles, but also in muscle-powered vehicles such as bicycles, for example.

In the field of bicycles different materials have stood the test, namely so called aluminum rims, steel rims, titanium rims and so called composite rims/composite material rims. Said composite rims in general can be understood to be rims comprising different materials. A specific subtype of such composite rims is also constituted by fiber composite rims, i.e. rims using reinforcing fibers, such as short fibers or long fibers. The fibers usually are embedded in resin. The resin is hardened during the manufacturing process so as to provide a fully completed rim. It is absolutely common to machine the surface of a finished rim product including reinforcing fibers by one or more finishing steps which are also of an abrasive nature.

The advantages of fiber composite rims have become obvious during the past 20 years, for rims of this type are lighter and stiffer compared to rims made of materials other than fibre composite materials. Such rims have stood the test especially in the high-end field for racing bikes, triathlon bikes and mountain bikes.

Unfortunately, the hitherto existing fiber composite rims are still too expensive and can be further optimized in terms of stiffness and lightness.

The invention addresses this problem with the object to eliminate or at least alleviate these known drawbacks. Especially a rim adapted to be machine-made and a method adapted to be used for the manufacture thereof are to be presented for improving cost potentials and enhancing the rim in terms of stiffness and lightness as compared to conventional rims.

This object is achieved, according to the invention, by the fact that the tire contact(ing) means is covered at least on the radial inside by a cover layer formed of at least one reinforcing thread so that a reinforcing ring is provided between the cover layer and the tire contact means.

Advantageous embodiments are claimed in the subclaims and will be illustrated hereinafter in detail.

It is of advantage when the reinforcing thread which may have a flat elongate shape, for example, includes a carbon fiber thread, aramid fiber thread and/or glass fiber thread or is formed by the same. Especially carbon fiber threads have particularly suited properties for rim construction.

In order to be able to connect the rim to a hub shell, it is advantageous when on a radial inside of the cover layer there are provided holes for receiving spokes which completely or partly penetrate also the reinforcing ring. Exactly in the domain of triathlon bikes or time trial bikes the aerodynamic values are of particular importance. Therefore it is of advantage when between the cover layer and the supporting layer an aerodynamics enhancing component, such as of the type of a spacing component, is provided. The aerodynamics enhancing component then is used for forming the external shape of the rim. The aerodynamics enhancing component can be made of foam-type material. The foam then also acts as sandwich core, for especially in this way the rim can be designed to have very thin wall thickness laminates of less than 1.0 mm, approximately 0.7 to 0.5 mm, without the rim surface bulging under load. This is a definite improvement compared to the hollow blow technology in prepreg engineering for rims common today and is a better alternative than even the pultrusion method. The pultrusion is not adapted to manufacture such thin wall thicknesses of approx 0.5 mm in the rim flank in a way suitable for fibers and said thin wall thicknesses then would bulge, i.e. would not remain non-deformable, without a sandwich core. The foam core has a sandwich function as regards global rim stiffness. The foam core has a stabilizing function as regards local bulging stiffness with the very thin surfaces of the rim laminate.

An advantageous embodiment is also characterized in that the aerodynamics enhancing component is arranged on the radial inside of the supporting layer and on the radial outside of the reinforcing ring and/or is covered/enclosed by the cover layer at its axial end face.

It is of advantage when the aerodynamics enhancing component is structured preferably completely of a foam material pressure-resistant up to approx. 10 bar or even up to approx. 50 bar and/or temperature-resistant up to 120° C. and/or even up to approx. 200° C., such as of Rohacell foam.

Also other polymethacrylimide structures are suitable, i.e. polymers, from which hard plastic (PMI) and hard foam (PMI-E), are manufactured, especially polyimides.

Especially these materials can be appropriately machined, have only low weight and are nevertheless sufficiently dimensionally stable when they are wound.

Storing is facilitated when the aerodynamics enhancing component is structured of plural segments adjacent to each other in circumferential direction.

Especially precise segments can be manufactured when each segment is shaped by machining, for example by grinding or turning. In order to detachably mount a tire, such as a clincher/clincher-tire or a hose tire, to the rim in a simple and permanent manner it is advantageous when the supporting layer and the cover layer form two adjacent webs.

It is advantageous when each web forms a braking flank and/or a rim edge provided/prepared for fastening, such by means of form and/or force closure, a tire/outer cover preferably by engaging behind the latter. Especially clincher then can be fastened by engaging there behind and radially outside of the brake flank in a good way. On the brake flank itself a grinding engagement area of brake pads, such as cantilever brake pads, can be realized.

It is useful when the two webs are formed as two axially spaced and mostly radially outwardly facing flange portions, the distal ends of which are facing each other, for example in the axial direction.

When the reinforcing thread is embedded in resin, such as epoxy resin, thermoset resin and/or thermoplastic resin, especially, loadable, stiff and at the same time light-weight rims can be formed. Especially in the field of bicycles this is of utmost importance.

A configuration such that the core of the tire contact means and/or the reinforcing ring are designed as a continuous annular incompressing component facilitates the application of the reinforcing threads during wrapping/winding and prevents an excessive concentrated load/point load on the segments. This prevents the reinforcing thread from constricting thereof.

In this context, it is also mentioned to be advantageous that the incompressing component can be configured e.g. as a hardened resin ring, for example with short and/or long fibers made of carbon, aramid or glass contained therein. Also combinations of short and long fibers as well as combinations of carbon fibers, aramid fibers and glass fibers are imaginable.

When the reinforcing ring is designed as full core or hollow core, i.e. for example including one or more hollow chambers, the weight then can be further reduced.

It is of advantage when the supporting layer is formed of two or more reinforcing threads which are adjacent to each other while forming a closed layer. It is imaginable in this context that areas of the thread overlap so as to form a closed layer. The continuous supporting layer may also be designed so that it extends in spiral shape over the circumference of the rim or is superimposed in plural spiral layers.

It is useful here when the supporting layer is formed of a first partial layer or of plural first partial layers in which the reinforcing thread or reinforcing threads are arranged preferably orthogonally with respect to the circumferential direction extending around the core, approximately at an angle of 85°+/−1° to 2°, of a second partial layer or second partial layers surrounding the first partial layer or first partial layers and including one reinforcing thread or plural reinforcing threads, which are arranged preferably in parallel to the circumferential direction, approximately at an angle of 0°+/−1° to 2° or at an angle of 16°+/−1°, 2°, 3°, 4° or 5° and of a third partial layer or third partial layers surrounding the second partial layer or second partial layers, wherein the third partial layer or the third partial layers include one or more reinforcing fiber(s) arranged in the way of the first partial layer or first partial layers.

For an apparatus/a machine applying the reinforcing thread or reinforcing threads to be controllable in a sufficiently precise manner it is advantageous when a ferromagnetic detection member, a magnet or a sensor is inserted in the core by force and/or form closure below the supporting layer.

Through the processing of the distal ends of the webs by way of willing, sawing, grinding and/or turning targeted material removal is effected, thereby allowing the geometries of the rim of the clincher engaging behind to be designed to be efficient and loadable.

With respect to the holes into which the spokes have to be inserted, it is of advantage when they are drilled, milled or punched.

It is expedient when the cover layer is coated and/or painted for example completely or at least partly with a coating on the outer surface.

The invention further relates to a method for manufacturing a fiber composite rim, for example of the type according to the invention, comprising the steps preferably carried out in time sequence:
a) wrapping/winding a preferably closed annular core with a reinforcing thread so as to deposit e.g. a continuous supporting layer on the core and to form a tire contact means.
b) positioning the tire contact means adjacent to an approximately annular aerodynamics enhancing component acting as a spacer and a reinforcing ring which preferably has a closed full-surface ring shape, and
c) wrapping the wire contact means, the aerodynamics enhancing component and the reinforcing ring with a reinforcing thread or plural reinforcing threads so that a cover layer is formed.

Such manufacturing method is cost-efficient even in high-wage countries and can be quickly carried out. The aerodynamics enhancing component adapted to be formed as a foam core has a supporting function for spacing apart and fixing the inner ring or plural inner rings so that the second ring wrapping/winding procedure is adapted to produce the laminate in an especially dimensionally stable and precise manner The foam core has a space-holding function in an RTM resin injection step such that it does not collapse under a pressure of 10 bar and up to 200° C. and the cavity resulting in this way is filled with unnecessary resin. The foam core also has a shaping function which ideally generates good aerodynamics

Also the method may be advantageously further developed, namely in that the aerodynamics enhancing component is composed of four segments of 90°. As a matter of course, also six segments of 60° are possible or such number of segments the degrees of which are resulting in a total of 360°. For example, five segments of 72° each and three segments of 120° each are suggested.

It is expedient when a pre-rim is created by the tire contact means, the aerodynamics enhancing component and the reinforcing ring holding together in a positive/form-fit and/or non-positive/force-fit manner.

An advantageous embodiment is also characterized in that the pre-rim is wrapped/wound with a cover layer made of one reinforcing thread or two or more reinforcing threads. Especially the use of two reinforcing threads has turned out to be especially advantageous.

It is useful when an area of the pre-rim containing one reinforcing thread or more reinforcing threads with or without a cover layer is infiltrated/soaked with resin and/or a reinforcing thread pre-impregnated with resin is utilized.

When, after the cover layer is applied and before/after the cover layer hardens, the radially outermost part of the cover layer and the supporting layer is cut through for example in a machining way, the core can be reached and then can be removed. In that case a clincher-rim can be easily provided.

It is advantageous in this context when cutting is realized by means of a milling step.

In order not to withhold the core by the portions of the rim edges facing each other, it is of advantage when the core is partly or preferably completely severed during cutting. The individual parts of the then severed core can be easily removed from the rim.

It is advantageous when during cutting, it is cut up to the inside of the radially inner part of the supporting layer.

Furthermore, it is of advantage when after cutting a bridge ring comprising a ring portion of the cover layer and of the supporting layer is removed and the core is removed so as to form the rim edges.

An advantageous embodiment is also characterized in that after hardening, holes for receiving spokes are introduced into the cover layer, the reinforcing ring and/or the aerodynamics enhancing component.

Here it is advantageous when the holes are drilled.

Finally it is referred to the effect that directly after the hardening or the drilling of the holes, paint can be applied or the outer surface of the cover layer can be painted so as to improve the recognition value. Moreover, for example a reflecting surface can be provided.

Hereinafter the invention shall be illustrated in detail by way of a drawing visualizing the method of manufacturing a rim according to the invention.

The FIGURE is merely schematic and only serves for the comprehension of the invention.

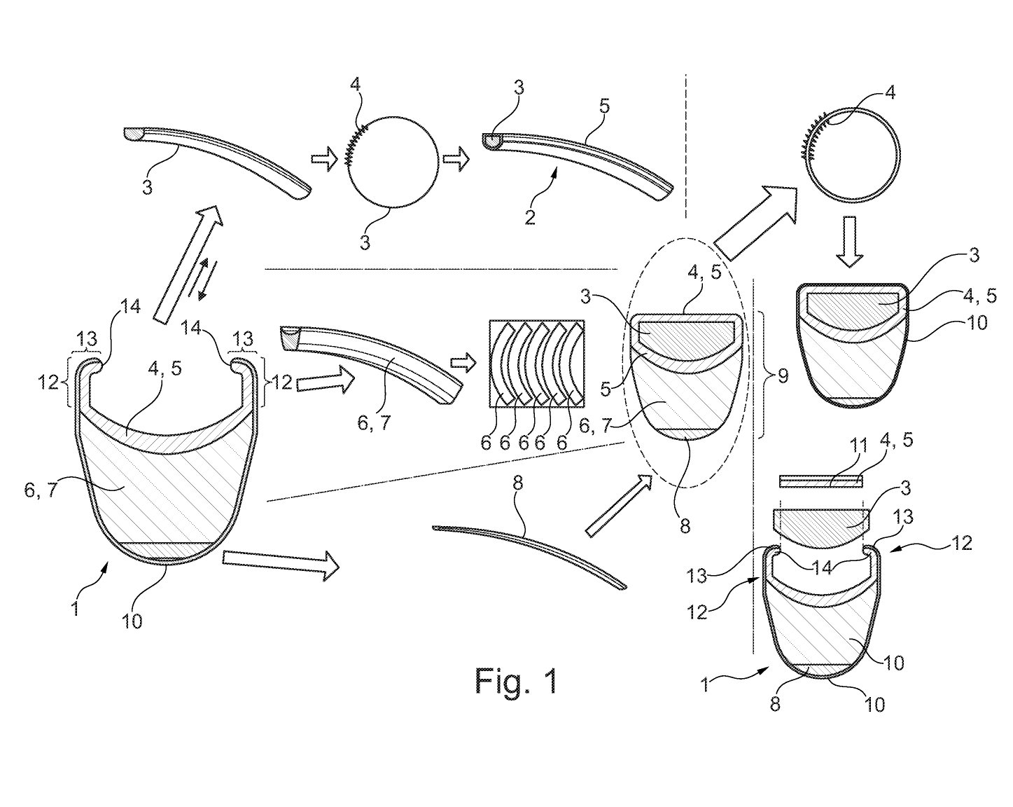

FIG. 1 illustrates the assembly of a rim 1 which is intended for use on a bicycle. The rim 1 includes a tire contact means 2. The tire contact means 2 comprises a core 3. The core 3 may be a glass fiber core. In the fully completed rim the glass fiber core is no longer contained.

The core 3 is wrapped with at least one reinforcing thread 4 such that a supporting layer 5 is formed. In the supporting layer 5 thus the reinforcing thread 4 is contained and embedded in a resin bed. The reinforcing thread 4 is applied by a winding means not shown. Preferably two reinforcing threads 4 are used to wind a first supporting layer 5 starting on a first side of the core 3, while on an opposite side of the core 3 a different supporting layer 5 is formed by a different reinforcing thread 4.

The two supporting layers 5 then “are growing” in the same circumferential direction. However, this cannot be inferred from FIG. 1. In this respect, it is referred to the document WO 2011/096805 A1 identified in the beginning, however.

An aerodynamics enhancing component 7 composed of plural segments 6 is clamped onto the radial inside of the core 3 surrounded by the supporting layer 5. Further radially inwards a reinforcing ring 8 is clamped.

These components form a pre-rim 9 as can be seen in the center of FIG. 1.

In a subsequent step the pre-rim 9 is wrapped in turn with the reinforcing thread 4 by a winding device, such as a toroidal winding device as known from WO 2011/096805 A1. In this way a cover layer 10 is formed.

The cover layer 10 hence also covers the radial outside of the core 3 just as the supporting layer 5.

The formation of the cover layer 10 may be carried out similarly or equally to the formation of the supporting layer 5. Thus especially plural reinforcing threads 4 can be used.

In a subsequent step the core 3 is exposed and severed. For this, a bridge ring 11 formed of a portion of the supporting layer 5 and of the cover layer 10 is removed, especially milled out or turned. Accordingly, also the core 3 is split into three parts. The two axially outer parts are of equal size. The three parts of the core as well as the bridge ring 11 then are removed and discarded. In this way, webs 12 having flange portions 13 are retained. On the inside thereof a clincher can be fastened engaging there behind.

Distal ends 14 of the flange portions 13 are aligned toward each other.

The fully completed rim 1 is represented on the lower left side of FIG. 1. It is mentioned that the core 3 may also be configured as a glass fiber fabric tape, as a latex component, rubber component, injection molded component or as a component based on a pultrusion step or an RTM process.

This applies mutatis mutandis to the reinforcing ring 8. Glass fiber cores and carbon fiber cores have also stood the test for exhibiting a sufficiently larger density and strength than foam. In this way constriction of the reinforcing fibers 4 into the segments 6 is prevented.

At the end of the manufacture, holes (not shown) are introduced into the cover layer 10 and the reinforcing ring 8. Also color coating and painting is possible.

The tire contact means 2 may also be referred to as tire contacting means. The rim 1 may be referred to as fiber composite rim.

The areas or portions of the pre-rim 9 containing the individual reinforcing threads 4 can be infiltrated altogether with resin, as is evident on the far right in FIG. 1, or else can be separately infiltrated, as represented in the middle of the Figure in the area of the pre-rim 9. In the case of such separate infiltration, the supporting layer 5 is infiltrated already shifted in time before infiltrating the cover layer 10.

Hardening is achieved, as is conventionally known, by an increase in temperature and/or an increase in pressure.

1. A rim for a vehicle comprising a tire contact means which is prepared for fastening a clincher or a tubed tire, wherein the tire contact means includes a core which is wrapped by at least one reinforcing thread so that the core is covered by at least one supporting layer formed by the reinforcing thread,
characterized in that the tire contact means is covered at least on the radial inside by a cover layer formed of at least one reinforcing thread so that a reinforcing ring is provided between the cover layer and the tire contact means.

2. The rim according to claim 1, characterized in that the reinforcing thread includes a carbon fiber thread, aramid fiber thread and/or glass fiber thread or is formed by the same.

3. The rim according to claim 1, characterized in that on a radial inside of the cover layer, holes for receiving spokes are provided which completely or partly penetrate also the reinforcing ring.

4. The rim according to claim 1, characterized in that an aerodynamics enhancing component is provided between the cover layer and the supporting layer (5).

5. The rim according to claim 4, characterized in that the aerodynamics enhancing component is arranged on the radial inside of the supporting layer and on the radial outside of the reinforcing ring and/or is covered by the cover layer on its axial end faces.

6. A method of manufacturing a fiber composite rim comprising the steps of:
a) wrapping a core with a reinforcing thread so as to deposit a supporting layer on the core and to form a tire contact means,
b) arranging the tire contact means adjacent to an aerodynamics enhancing component and a reinforcing ring, and
c) wrapping the tire contact means, the aerodynamics enhancing component and the reinforcing ring with one reinforcing thread or plural reinforcing threads such that a cover layer is formed.

7. The method according to claim 6, characterized in that the aerodynamics enhancing component is composed of four segments of 90°.

8. The method according to claim 6, characterized in that a pre-rim is produced by a form-fit and/or force-fit holding together of the tire contact means of the aerodynamics enhancing component and the reinforcing ring.

9. The method according to claim 8, characterized in that the pre-rim is wrapped with the cover layer made of one reinforcing thread or two reinforcing threads.

10. The method according to claim 8, characterized in that an area of the pre-rim with or without cover layer including one reinforcing thread or plural reinforcing threads is infiltrated with resin and/or a reinforcing thread pre-impregnated with resin is used.
